(19) United States
(12) Patent Application Publication
(10) Pub. No.: US 2021/0321726 A1
(43) Pub. Date: Oct. 21, 2021

(54) METHOD FOR PROTECTING SKIN FROM ABRASION DURING PROLONGED WEARING OF A FACE MASK

(71) Applicant: BibBoards, Inc., San Ramon, CA (US)

(72) Inventor: Eric Jourgensen, West Palm Beach, FL (US)

(73) Assignee: BibBoards, Inc., San Ramon, CA (US)

(21) Appl. No.: 16/852,405

(22) Filed: Apr. 17, 2020

(51) Int. Cl. A44B 17/00; A41D 13/12

(52) U.S. Cl. CPC A44B 17/0005; A41D 2400/44; A41D 13/129

(57) ABSTRACT

A new use for a previously known snap fastener protects against raw ears or other uncomfortable abrasion during face mask use, particularly prolonged use of one mask or uninterrupted sequential use of multiple masks. A user selects two locations on a piece of headwear that would be near the ears, and puts snap fasteners at those locations. The snap fasteners have “wiggle,” and therefore can receive the elastic loops of the face mask and hold them securely. This removes the force load from the back of the ears, thus encouraging proper face mask use and significantly eliminating discomfort.

### BACKGROUND OF THE INVENTION

The 2019-2020 novel coronavirus pandemic has required an unprecedented public health response. Among the most important measures that experts recommend for curtailing or slowing the spread of the virus is the wearing of face masks. Experts believe that proper use of a face mask will do some or all of the following: (1) protect the wearer from inhaling droplet or aerosol suspensions containing significant amounts of the virus sourced from other people; (2) protect people around the wearer in case the wearer is infected (knowingly or unknowingly) where, absent a face mask, such person emanates virus-laden droplets or aerosol; and (3) disincentivize touching of one's own face—a commonly understood pathway of infection for the virus into a person's airways or mucous membranes.

Among health care workers and others on the front lines of pandemic response, face masks are mandatory. Moreover, especially among such front-line workers, certain protocols are recommended. This may include not removing a face mask for a prolonged period, or otherwise wearing multiple face masks in sequence but with little time in between to rest the skin.

Among the general public, pandemic response has increasingly required donning of face masks when in public, particularly when social distancing recommendations are not possible to follow (for example, in crowded grocery stores). Members of the general public are likely new to face mask use, and thus particularly susceptible to their discomfort.

Face mask discomfort could have deadly results. For example, a person's natural inclination is to loosen or doff a mask when it becomes uncomfortable. But doing so at the wrong time could forfeit the very protections the mask ought to provide.

One of the most common face mask designs, mass produced cheaply and readily available, is the double ear loop mask. Such a mask has two elastic bands designed to hook behind the ears. The bands are connected to opposite edges of the region of material that covers the nose and mouth. This widely used mask design is particularly susceptible to face mask discomfort. Most people will report “raw ears” (caused by unavoidable abrasion) when they have to wear such face masks for a prolonged period of time. As mentioned, no matter how experienced or determined to follow protocol the wearer might be, the discomfort of such raw ears could lead to deadly behavior patterns—misuse of the face mask against recommended protocols.

Endurance sports and recreational athletics are separate fields from that of medical face masks. Within the fields of sports and athletics, participants have long used safety pins to fasten racing numbers (or bibs) to their clothing. Safety pins have significant disadvantages, such as the inherent danger of working with a sharp point, as well as their tendency to ruin expensive athletic clothing by the holes they cause. In recent years, alternatives to safety pins have become increasingly popular. One example is BIBBOARDS® (available from BibBoards, Inc. of San Ramon, Calif.). BIBBOARDS® is a two-piece nylon-plastic fastener that advantageously replaces safety pins. In typical use, BIBBOARDS® go on the four corners of a racing number to fasten the number to a garment. FIG. 1 (prior art) depicts the front and back of a typical BIBBOARDS® 100. A back piece 10 would go behind the garment (the skin side), while a front piece 20 would go in front to be visible on the outside. Snapping back 10 and front 20 together results in the fastener sandwiching both the garment and the racing number between the pieces. FIG. 2 (prior art) depicts how BIBBOARDS® 100 appear on a typical garment with racing bib after all four fasteners are snapped—one BIBBOARD® 100 fastens each corner of the bib to the garment.

BIBBOARDS® 100 does not damage fabric the way that safety pins do. This is because the principle of operation involves a stud on the front piece with a knob on the end, mating through a hole in the back piece with a thin lip of flexible plastic. The flexibility of the deliberately thinner plastic, as it permits passage in both directions for the knobby end of the stud, allows for easy connection and disconnection of the fastener. FIG. 3 (prior art) shows a connected front and back piece in situ, from the back. As shown, the garment's fabric is slightly stretched at the place where the knobby end pushes it through the back piece's hole. This avoids the damaging puncture previously required by safety pins. It has been observed that this stretch does not materially damage fabric, since any dimple it creates will easily rub or wash out. Other aspects of the BIBBOARDS® 100 structure that can be discerned from FIGS. 1 and 3 include the dome-like roundness of the region of the back piece that would be nearest a wearer's skin. As a result, BIBBOARDS® 100 will not chafe the user when worn.

Because of the length of the stud on the front piece that terminates in the knobby end, there is some give when BIBBOARDS® 100 is completely fastened. That is, it wiggles a little bit. It creates a secure reversible connection, yet permits some space and openness to exist between the front and the back pieces.

Yet a further advantage of BIBBOARDS® 100 observed in the sports and athletics fields is its ability to serve as a mode of self-expression. The front piece opposite the side with the stud is an oval plane. It is relatively straightforward to print logos or meaningful sayings on this surface (e.g., with a commercial surface printer suitable for printing on nylon).

### BRIEF SUMMARY OF THE INVENTION

The present invention involves a new use for the previously existing BIBBOARDS® 100. The method described herein involves the use of BIBBOARDS® 100 outside of its originally intended context. In particular, rather than the fields of sports and athletics, the present invention uses BIBBOARDS® 100 in the field of medical face masks. The method of use advantageously deploys BIBBOARDS® 100 to serve as an alternative hooking location for the elastic band of a typical face mask. This is done by placing the removable snap fastener in locations near the ear on an item of headwear, such as a cap, hat or band. After such placement, one hooks the elastic straps around the loose-yet-secure fastener, rather than around the back of the ears. This new use has been discovered to eliminate or sharply minimize raw ears. In turn, the new use of BIBBOARDS® 100 to hook face masks has been found to encouraged compliance with personal protective equipment (PPE) protocols in medical settings, and has removed a primary disadvantage of face mask wearing for the general public.

### BRIEF DESCRIPTION OF THE DRAWINGS

FIG. 1 (prior art) depicts a plan view of BIBBOARDS® 100, front and back pieces.

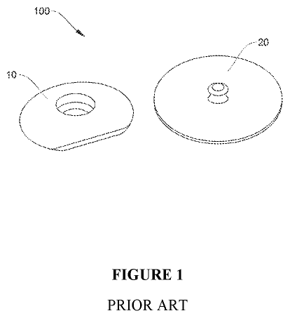

FIG. 2 (prior art) depicts the placement of BIBBOARDS® 100 on each of the four corners of a racing bib to attach it to a racing garment.

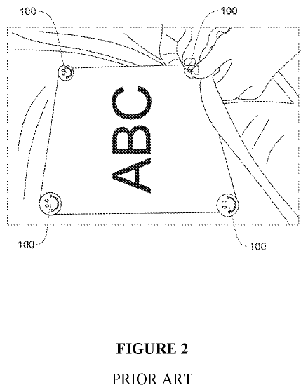

FIG. 3 (prior art) shows a plan view of the back piece of BIBBOARDS® 100 in situ, how the knobby end of the stud on the front piece connects through the garment's fabric through the hole with flexible lip of the back piece.

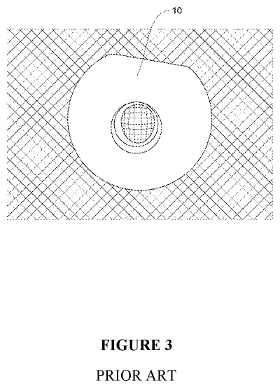

FIG. 4 depicts the result of the method of the present invention, showing a face mask hooked through BIBBOARDS® 100 on each side of a cap near the ears.

FIG. 5 is a flow diagram of one embodiment of the method of the claimed invention.

### DETAILED DESCRIPTION OF THE INVENTION

The foregoing summary, as well as the following detailed description of the preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

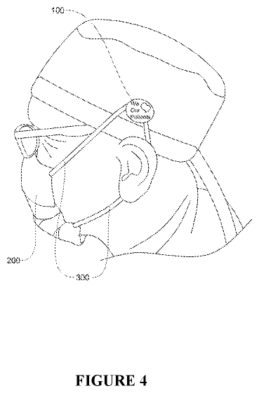

Referring to FIG. 4, there is shown a person wearing a face mask 200 that has an elastic loop 300 ordinarily designed for placement around the ears, such that the elastic remains in constant contact with the back of the ear. What distinguishes the invention from common use of such face masks is (as depicted in FIG. 4) the use of a snap fastener that leaves space between it and the fastened garment (e.g., BIBBOARDS® 100) to bear the force of such elastic band, instead of the back of the ear. Though not shown, it is understood that the other side of the face mask is similarly equipped with a snap fastener. In FIG. 4, the wearer is shown wearing a surgical cap. However, the method of the claimed invention works as well with any type of headwear known in the art that is made of a fabric or woven material, such as bands or even baseball caps.

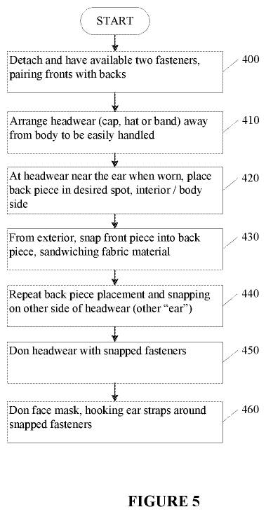

Referring to FIG. 5 is a flow diagram depicting an embodiment of a method for practicing the invention. At step 400, a user will detach and have available two fasteners, one to replace the back of each ear in receiving the force of an elastic face mask band. Each fastener (preferably a snap fastener) will have two fronts and two backs. The use of a snap fastener is advantageous because it allows for customized and optimized placement of the hook location each time, and also allows for separate sanitation and sterilization of the fasteners apart from the headwear.

At step 410, the user arranges the headwear away from the body for easy access to its inside and outside, and for proper handling.

At step 420, the user selects a location that would be near an ear when the headwear is worn. The user places a back piece of the fastener there, ready to receive a front piece's knobby end.

At step 430, from the exterior of the headwear, the user snaps the front piece into the back piece, sandwiching the fabric material. At this point, if using BIBBOARDS® 100, the fastener is highly secure yet easily removable, yet has “wiggle” that makes the front piece advantageously separate slightly at will from the headwear fabric.

At step 440, steps 420 and 430 are repeated on the other side, near the other ear.

At step 450, the user now dons the headwear, whatever type it may be.

Finally, at step 460, the user dons the face mask. Rather than conventionally hooking the elastic loops around the ears, where the backs of the ears carry the force load, the user hooks the elastic loops around the front piece of the snap fasteners (such as BIBBOARDS® 100). There, because of the “wiggle,” the elastic material fits well within the fastener assembly, and gets sandwiched there. In this way, the snap fastener, and not the back of the ear, carries the force load of the elastic straps. The method thereby prevents raw ears, and encourages proper mask use during pandemics or other situations requiring face masks, especially prolonged or sequential uninterrupted use.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined by the appended claims.

1. A method of donning a medical face mask comprising:
(a) selecting a location on an interior of a headwear item that would be near an ear when the headwear item is worn;
(b) aligning a back piece of a first two-piece snap fastener to the selected location;
(c) aligning a front piece of the first two-piece snap fastener to an exterior of the headwear item opposite the location of the aligned back piece;
(d) bringing the back and front pieces together to securely but removably fasten the first two-piece snap fastener;
(e) repeating steps (a) through (d) at a location that would be near the other ear for a second two-piece snap fastener;
(f) donning the headwear item comprising the two snap fasteners;
(g) donning a face mask that comprises a first and second elastic loop by placing the first loop around the first two-piece snap fastener and placing the second loop around the second two-piece snap fastener.

2. The method of claim 1 wherein each two-piece snap fastener comprises a back piece having a hole surrounded by a flexible lip, and a front piece having a stud terminating with a knob, such that closure of the snap fastener occurs by the knob passing beyond the flexible lip into the hole, and opening of the snap fastener occurs by the knob passing outside the flexible lip out of the hole.

3. The method of claim 2 wherein each stud has a length sufficient to permit wiggle of the front piece with respect to the back piece while the snap fastener is in a fastened condition.

4. The method of claim 1 wherein the headwear is a baseball cap.

5. The method of claim 1 wherein the headwear is a surgical cap.

6. The method of claim 1 wherein the headwear is a headband.

7. The method of claim 1 wherein each two-piece snap fastener comprises a front piece that comprises a plane configured for receiving the printing of imagery or text.

8. The method of claim 1 further comprising the steps of:
(h) removing the face mask by removing the elastic loops from around each two-piece snap fastener; and
(i) unsnapping the front and back pieces of each snap fastener, to result in separated snap fastener front and back pieces that may be re-applied in a future use.

9. A method of donning a medical face mask comprising:
(a) selecting a location on an interior of a headwear item that would be near an ear when the headwear item is worn;
(b) aligning a back piece of a first two-piece fastener to the selected location;
(c) aligning a front piece of the first two-piece fastener to an exterior of the headwear item opposite the location of the aligned back piece;
(d) bringing the back and front pieces together to securely but removably fasten the first two-piece fastener;
(e) repeating steps (a) through (d) at a location that would be near the other ear for a second two-piece fastener;
(f) donning the headwear item comprising the two fasteners;
(g) donning a face mask that comprises a first and second elastic loop by placing the first loop around the first two-piece fastener and placing the second loop around the second two-piece fastener.

10. The method of claim 9 wherein each two-piece fastener comprises a back piece having a hole and a front piece having a stud, such that closure of the fastener occurs by the stud passing into the hole, and opening of the fastener occurs by the stud passing outside of the hole.

11. The method of claim 10 wherein each stud has a length sufficient to permit wiggle of the front piece with respect to the back piece while the fastener is in a fastened condition.

12. The method of claim 9 wherein the headwear is a baseball cap.

13. The method of claim 9 wherein the headwear is a surgical cap.

14. The method of claim 9 wherein the headwear is a headband.

15. The method of claim 9 wherein each two-piece fastener comprises a front piece that comprises a plane configured for receiving the printing of imagery or text.

16. The method of claim 9 further comprising the steps of:
(h) removing the face mask by removing the elastic loops from around each two-piece fastener; and
(i) separating the front and back pieces of each fastener, to result in separated fastener front and back pieces that may be re-applied in a future use.
